(19) United States
(12) Patent Application Publication
(10) Pub. No.: US 2019/0005409 A1
(43) Pub. Date: Jan. 3, 2019

(54) LEARNING REPRESENTATIONS FROM DISPARATE DATA SETS

(71) Applicant: Facebook, Inc., Menlo Park, CA (US)

(72) Inventors: Harsh Doshi, San Francisco, CA (US); Kai Ren, Belmont, CA (US); Sagar Chordia, Redwood City, CA (US)

(21) Appl. No.: 15/639,885

(22) Filed: Jun. 30, 2017

(51) Int. Cl. G06N 99/00; G06N 5/04

(52) U.S. Cl. CPC G06N 99/005; G06N 5/04

(57) ABSTRACT

Methods and systems are described herein for jointly training embeddings. The method involves identifying a first data set describing occurrences of a first event type and identifying a second data set describing occurrences of a second event type, in which the first data set and the second data set include a set of users in common. The method further involves jointly training a set of embeddings a joint set of users, involving training the set of users in common based on co-occurrences of events of the first event type first data set and co-occurrences of events of the second event type in the second data set. The method further involves training a computer model that predicts the likelihood of occurrence of a future event for a user with respect to a content item based on the embedding for the user in the jointly trained set of embeddings.

### BACKGROUND

This invention relates generally to machine-learned representations and learning latent representations to be used for an event prediction based on a data set for that event and data sets for other events.

Latent representations may be used in computer models to describe characteristics of an object, such as a content item, page, or actor, in terms that may not be readily understood or defined by human analysis. As one example of latent representation, objects may be described as a vector of values called an embedding. The embedding may be used to represent the object in further analysis of the object, such as to predict the occurrence of an event occurring between two objects.

To predict an event between two objects, such as a user's action when presented with a content item, each user and each content item may be represented as an embedding. These embeddings may be learned for a set of users and content items based on a training set of interactions of users with content items. Generally, these embeddings may be limited in usefulness to predicting the event for which the embedding is trained and may not be effective for predicting other events. However, embeddings trained in this way may be limited by the size of the training set, and in some cases a sparse or insufficient training set can result in embeddings that do not effectively represent the objects. For example, a model may learn embeddings for users and advertisements to predict the likelihood of a conversion event occurring after presentation of the advertisement to a user. However, if a low percentage of users performs the conversion event, this provides a small training set of positive examples for training the embedding. Because of the small training set, the embeddings may not effectively represent the true characteristics of the users and advertisements in the training set. This may commonly occur for a “cold start”—when a new event is measured and training data is accumulated for that new event. As that new event is measured, the initial training data is very small and embeddings trained on this data may significantly err in representing the “true” characteristics of objects. For example, if data in a data set relating to advertising content shows that only a few, similar users had a positive response to an advertisement, a computer model based on the embedding generated for this advertisement may only suggest providing that advertisements to a small set of similar users. Thus, the advertisement's embedding is over-trained for that type of user, causing over-exposure for that type of user.

In addition, the learned embeddings may over-learn the characteristics of the training set for that event and reflect the training set data too specifically rather than more general characteristics of the population of users and objects in the training set. When the learned embeddings are also used to determine which content items are presented to which users, this can also result in the selection of content items based on predictions from these initial embeddings that are too narrow and fail to effectively explore other types of users.

### SUMMARY

To improve the trained embeddings for predicting an event, embeddings are learned for predicting a first type of event based on two data sets: a first data set for the first type of event, and a second data set reflecting a second type of event. Each data set may reflect the occurrence of an event after the presentation of a content item to a user. Thus, each event may describe different types of events (e.g., viewing, clicking, or reacting to content), and each data set may reflect different sets of content items (e.g., different types of content) and different sets of users. There may be some overlap between the users and/or the content items, so that, for example, a set of users described by the first data set are also described by the second data set. By supplementing the first data set with the second data set, the embeddings used to predict the first action may better represent the content items and users.

For example, a first data set may include data that pairs users to sponsored content items, such as advertisements. When a user is presented with a sponsored content item and performs some action, such as clicking on a link in the sponsored content item, the system logs this event in the first data set. The second data set may include data that pairs users to un-sponsored presentation of content items (“organic content”), e.g., posts from other users. When a user is presented with organic content and performs some action, such as clicking on a link in the organic content, the system logs this event in the second data set. If users respond to organic content more than they respond to sponsored content, the second data set will include more data reflecting positive events (i.e., user-content pairs describing a user action) than the first data set. In this case, the first data set is comparatively sparse, with fewer positive events to model. This makes it difficult to create a good model for how users will respond to advertising content based on the data in the first data set alone. However, the second data set may be used to provide additional information about the users/and or content included in the first data set and thereby improve the modeling for the first event. In particular, combining knowledge about how users respond to advertising content with how users respond to organic content can create a more robust model for predicting how users respond to advertising content. To combine the data sets, the methods and systems described herein train joint embeddings based on multiple data sets, and then train a computer model describing the likelihood for the first event with the jointly trained embeddings.

Since multiple data sets of different sizes are used to train the joint embeddings, the system can apply appropriate weights to the data sets used to train the embeddings so that one data set does not drive the embeddings disproportionately. Alternatively, the system can sample one or more of the data sets to create input data sets to the embedding that have the desired proportions.

In some embodiments, the system determines matching items between the data sets. For example, the system may determine matching users between the data sets or determine matching content items between the data sets (e.g., the same link to a website may be included in both an advertisement and a user post). The same objects may be determined based on the embedding that describes the objects, or based on other data identifying the objects.

The system can be used with a wide variety of event types. For example, the system may log any type of event within a website or application, such as a social networking website or application, in a data set. Event types can include posts, reposts, selecting or creating internal links, reactions, views, video views, etc. The system may also log events that extend or take place outside of the website or application, such as selecting or creating external links, interacting with external content, making a purchase, adding an item to a shopping cart, installing an app, attending an event, etc. The system may use pixel tracking to log external events.

The joint embeddings described herein may reduce over-training and lack of exploration that may occur with a small or sparse dataset. To overcome these problems, embeddings are jointly trained, i.e., the embeddings are based on data from more than one data set. By expanding the amount of data used to train the embeddings, the system avoids over-training embeddings on sparse data. Further, the additional data about other users may lead the model to suggest different users to provide the advertisement or similar advertisements. Thus, the additional data prevents over-exploitation of one set of objects, and promotes intelligent exploration of objects that may not be explored when embeddings are trained using a single data set.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 illustrates a first data set describing one event type and a second data set describing a different event type, in accordance with an embodiment.

FIG. 4 is a flow diagram showing the creation and use of a joint embedding, in accordance with an embodiment.

FIG. 5 is an illustration of an interaction between joint embeddings, in accordance with an embodiment.

FIG. 6 is a flow diagram of a method for training a computer model that uses joint embeddings, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

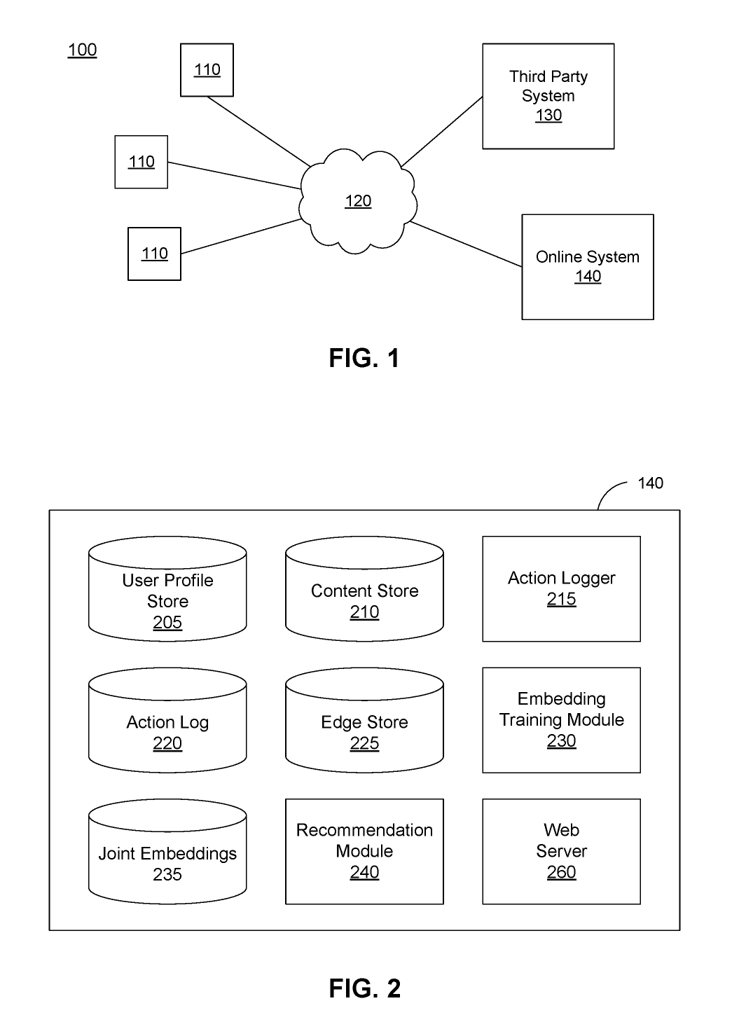

FIG. 1 is a block diagram of a system environment 100 for an online system 140, according to one embodiment. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users. The online system 140 provides content items to client devices 110, which may be provided by the third party system 130 or by users of other client devices 110. In providing these content items, the online system 140 may track the occurrence of various events, predict the likelihood of various events with computer models, and use these predictions in the selection of content items for presentation on the client devices 110 to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140, according to one embodiment. The components of the online system 140 provide modules and components for tracking events performed by users and learning joint embeddings from multiple data sets to improve predictions for the data sets. For example, a joint embedding can be learned for one data set relating to a first event, as well as a data set for another event, and this joint embedding used for predicting occurrence of the first event. The online system 140 shown in FIG. 2 includes a user profile store 205, a content store 210, an action logger 215, an action log 220, an edge store 225, an embedding training module 230, joint embeddings 235, a recommendation module 240, and a web server 260. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represents various types of content. Examples of content represented by an object include a page post, a status update, a photograph, a video, a link, a shared content item, a gaming application achievement, a check-in event at a local business, an advertisement, a brand page, or any other type of content. Online system users may create objects stored by the content store 210, such as status updates, photos tagged by users to be associated with other objects in the online system 140, events, groups, or applications. In some embodiments, objects, such as advertisements, are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

In various embodiments, a content item includes various components capable of being identified and retrieved by the online system 140. Example components of a content item include: a title, text data, image data, audio data, video data, a landing page, a user associated with the content item, or any other suitable information. The online system 140 may retrieve one or more specific components of a content item for presentation in some embodiments. For example, the online system 140 may identify a title and an image from a content item and provide the title and the image for presentation rather than the content item in its entirety.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identify users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and external to the online system 140 and populates the action log 220 with information about these user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

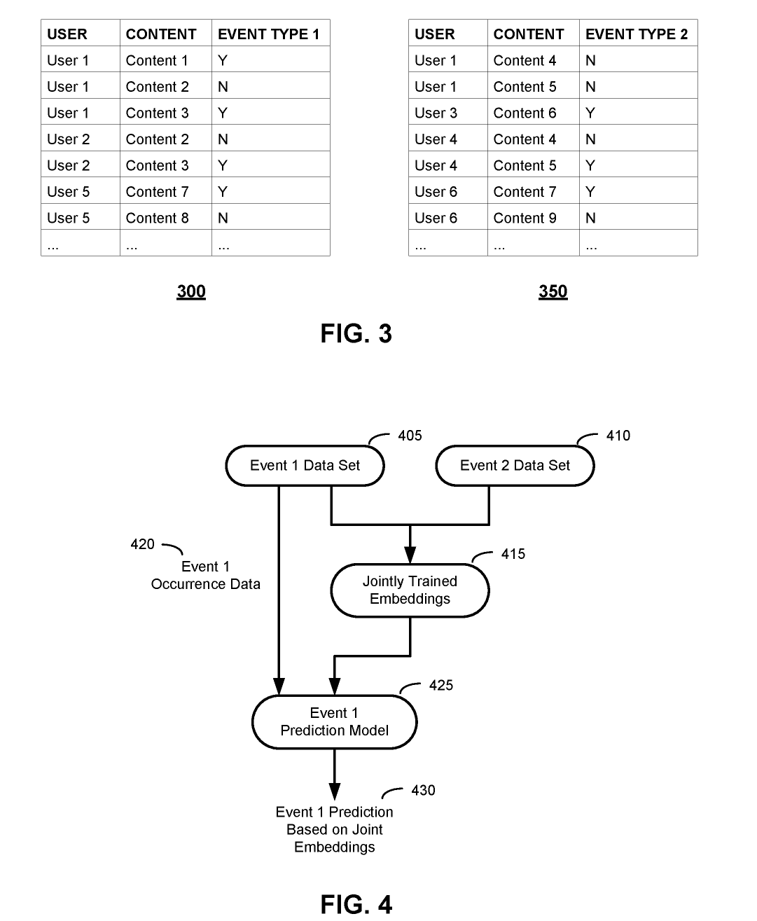

The action log 220 may include multiple individual data sets or databases, each storing information describing one particular type of event or relating to one particular type of content or set of content. For example, a user may be able to make several types of actions related to a video: viewing, reacting, commenting, posting, etc. Each of these actions is considered an event type, and data describing each of these event types may be stored in the action log 220 as a separate event data set, as described with respect to FIG. 3.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The embedding training module 230 applies machine learning techniques to generate joint embeddings 235 that includes embedding vectors for entities of the social networking system 140 that describes the entities in a latent space. As used herein, latent space is a vector space where each dimension or axis of the vector space is a latent or inferred characteristic of the objects in the space. Latent characteristics are characteristics that are not observed, but are rather inferred through a mathematical model from other variables that can be observed by the relationship of between objects in the latent space.

The joint embeddings 235 are trained based the event data sets in the action log 220. In particular, a set of joint embeddings 235 is trained based on two or more event data sets in the action log 220. As one example, the joint embeddings 235 can be trained using a stochastic gradient descent algorithm based on entity co-engagement with one or more events. That is, the joint embeddings 235 can be trained so that the distance between the embedding vectors of different entities is proportional to the level of co-engagement of the entities. As used herein, co-engagement refers to two or more entities being engaged with by a same user. That is, a first entity and a second entity are said to be co-engaged if a user interacts with both the first and second entities. Furthermore, the level of co-engagement of two or more entities is proportional to the number of users that engaged with all of the two or more co-engaged entities. Co-engagement may also refer to the co-engagement of an entity or content item by two or more users.

During the training of the joint embeddings 235, an entity, such as a user or content item is represented as a bag of historically engaged entities. With a user as an example entity, the user is represented as a group of entities (e.g., content and/or users) the user has previously interacted with. In some embodiments, the user is represented as the last N entities the user interacted with. In other embodiments, the user is represented as all the entities the user interacted with within a preset time period (e.g., within the past 3 months). In yet other embodiments, the user is represented a bag of randomly chosen historically engaged entities.

To generate a positive training sample, one entity of the representation of the user is picked out and the embedding vector of the picked entity is determined based on the other entities remaining in the representation of the user. The embedding training module 230 then updates the joint embedding 235 based on the embedding vector of the positive training sample.

To generate a negative training sample, an entity the user has not engaged with is randomly chosen and the embedding model is applied to the randomly chosen entity. The embedding training module then updates the joint embedding 235 based on the embedding vector of the negative training sample. A user “not engaging with” an entity can be represented as a 0 or N in the data set described with respect to FIG. 3.

In some embodiments, the embedding training module 230 trains the joint embeddings 235 using a lock-free parallel stochastic gradient descent (SGD). Since inputs are sparse and high dimensional, the probability of collision of active weights is low. As such, multiple computing threads may be used in parallel to randomly obtain one training sample, and update the model based on the obtained training sample.

The recommendation module 240 identifies entities to users based on the joint embedding vectors determined for each of the entities in the social networking system. As discussed below, these embedding vectors may be jointly trained across multiple data sets. In some embodiments, the recommendation module 240 provides entity recommendations based on the similarity to entities the user has previously interacted with (entity-entity recommendations). To provide the entity-entity recommendations, the recommendation module 240 identifies entities based on the similarity or distance between the embedding vector of the entity and the embedding vector of the entities the user has previously interacted with. The recommendation module 240 may calculate a cosine similarity score between target entities the user has not previously interacted with and historical entities the user has previously interacted with. That is, the recommendation module 240 may calculate an inner product between the embedding vector of a target entity and the embedding vector of a historical entity. The cosine similarity scores for multiple entities are then ranked and the recommendation module may select the top ranked entities to be recommended to the user.

In some embodiments, the recommendation module 240 includes an event model that learns relationships between joint embeddings and a data set in order to generate a prediction model, as shown in FIG. 4. In other embodiments, the recommendation module 240 provides entity recommendations based on the distance between the embedding vectors of entities and a user vector that is determined based on the embedding vectors of the entities the user has previously interacted with (user-entity recommendations). In some embodiments, the recommendation module 240 may weight different types of interactions a user had with different entities when generating the joint embeddings. Types of interactions may include, watching a video associated with an entity, commenting on an entity, liking an entity, and sharing an entity. For instance, pages that a user shared may have a greater weight than pages that the user liked but did not share. In some embodiments, the weight may also account for a time decay based on how long ago the user interacted with the entity. That is, interactions that happened a longer time ago would have a smaller weight than interactions that happened more recently. To provide the user-entity recommendations, the recommendation module 240 may calculate a cosine similarity score between target entities the user has not previously interacted with and the user vector, rank the target entities based on the cosine similarity scores, and select the top rated ranked entities to be recommended to the user.

In yet other embodiments, the recommendation module 240 provides entity recommendations to a target user based the entities previously interacted by other users with user vectors that are close to the user vector of the target user (user-user recommendations). To provide the user-user recommendations, the recommendation module 240 determines cosine similarity scores between the user vector of multiple other users and the user vector of the target user. The recommendation module 240 then ranks the other users based on the cosine similarity scores and selects entities previously interacted by the top ranked users for being recommended to the target user.

Since the number of entities in a social networking system may be large, exhaustive search may not be realistically possible. Instead, the recommendation system may partition the search space based on predetermined rules and then may perform a more exhaustive search in one or more partitions.

The web server 260 links the online system 140 via the network 120 to the one or more client devices 110, as well as to the one or more third party systems 130. The web server 260 serves web pages, as well as other content, such as JAVA®, FLASH®, XML, and so forth. The web server 260 may receive and route messages between the online system 140 and the client device 110, for example, instant messages, queued messages (e.g., email), text messages, short message service (SMS) messages, or messages sent using any other suitable messaging technique. A user may send a request to the web server 260 to upload information (e.g., images or videos) that are stored in the content store 210. Additionally, the web server 260 may provide application programming interface (API) functionality to send data directly to native client device operating systems, such as IOS®, ANDROID™, or BlackberryOS.

As discussed above, the data used to generate embedding can be stored separately in event-specific data sets in the action log 220. For example, the action log 220 may include a separate data set for each type of content. The action log 220 may further separate the data for each type of action a user can take with respect to content (e.g., viewing, selecting, linking, etc.). As used herein, an event type describes a particular type of action as it is related or performed by to a particular type of content and/or user. For example, event types may include viewing an organic video, viewing sponsored content, selecting sponsored content, commenting on organic content, etc. As described with respect to FIGS. 4-6, the embedding training module 230 can ingest multiple data sets in the action log 220, each relating some set of users and some set of content to individual event types, and create joint embeddings 235 that are based on the multiple sets of data.

FIG. 3 illustrates a first data set 300 describing one event type and a second data set 350 describing a different event type, in accordance with an embodiment. Data set 300 includes the data fields “user,” “content,” and “event type 1.” Data stored in the “user” field identifies a user. Data stored in the “content” field identifies a content item. Data stored in the “event type 1” field identifies whether or not an event of type 1 occurred when a user was exposed to content. Each row of data set 300 includes a user identifier and a content identifier. The data set is populated by this user-content pair when a user is exposed to relevant content. For example, when User 1 was exposed to Content 1, the data set 300 was populated with the user-content pair User 1-Content 1. The “event type 1” field is populated based on whether User 1 does or does not perform a given action, in this case, the Event Type 1 action. For example, if data set 300 describes whether users viewed advertising videos when they were presented to them, the “Y” entry in the first row of data set 300 indicates that User 1 viewed the advertising video referred to as Content 1. The “N” entry in the second row of data set 300 indicates that User 1 did not view Content 2. As shown in data set 300, each user and each content item can be included in the data set 300 multiple times, e.g., when different users are exposed to the same content, or when different content is exposed to the same user. Further, the data set 300 may not include some user-content pairs. For example, since User 2 was not exposed to Content 1, this user-content pair is not in data set 300. As another example, while User 3 may be capable of viewing advertising videos, data set 300 may not include any user-content pairs involving User 3 if User 3 has not yet been exposed to any relevant advertising content.

Data set 350 is a second data set including user-content pairs for a second type of event, Event Type 2. Data set 350 has the same structure as data set 300, but it describes a different type of event, e.g., views of a video displayed in a non-sponsored or “organic” selection process or location. For example, a video selected for a newsfeed of a user that was not sponsored for the placement may be considered an “organic” video placement that may be interacted with by the user. In this example, a “Y” entry indicates that a user in a user-content pair viewed the organic video specified by the user-content pair, and an “N” entry indicates that a user in a user-content pair did not view the organic video specified by the user-content pair. The data set 350 may have some overlapping users with the data set 300, and the data set 350 may have some overlapping content with the data set 300. For example, User 1 appears in both data sets 300 and 350, and Content 7 appears in both data sets 300 and 350. Content 7 may be a video that was created and posted by an advertiser, and was separately posted by an individual user, so it can be considered both organic content with respect to second data set 350 and as sponsored content with respect to first data set 300.

The data sets 300 and 350 may describe any type of event, and any set or subset of content items presented by the system. In some embodiments, the data sets 300 or 350 describe events that are tracked using a pixel tracker. The data sets 300 and 350 may be collected by the action logger 215 and stored in the action log 220, as described with respect to FIG. 2. In some embodiments, the first data set 300 or the second data set 350 includes only positive data or negative data, i.e., only “Y” events or only “N” events.

FIG. 4 is a flow diagram showing the creation and use of a joint embedding, in accordance with an embodiment. Two event data sets, Event 1 Data Set 405 and Event 2 Data Set 410, are used to train the jointly trained embeddings 415. The Event 1 Data Set 405 and Event 2 Data Set 410 may be similar to the data sets 300 and 350 described with respect to FIG. 3, and may be stored in the action log 220 described with respect to FIG. 2. For example, the Event 1 Data Set 405 may include a set of user-content pairs associated with data indicating whether each user in a user-content pair viewed the advertising video specified by the user-content pair. Event 2 Data Set 410 may include a set of user-content pairs associated with data indicating whether each user in a user-content pair viewed the video specified by the user-content pair.

The embedding training module 230 creates the jointly trained embeddings 415, which may be stored as joint embeddings 235. The jointly trained embeddings 415 may include both user embeddings and content embeddings. That is, both entities and content items may be represented by embeddings. In general, the jointly trained embeddings 415 are based on co-occurrences of events within Event 1 Data Set 405 and Event 2 Data Set 410. For example, an embedding for a user may be based on co-occurrences of multiple events involving that user (e.g., the user selecting two view three different videos) reflected in Event 1 Data Set 405. The jointly trained embeddings are based on both Event 1 Data Set 405 and Event 2 Data Set 410. For example, if a user appears in both the Event 1 Data Set 405 and the Event 2 Data Set 410, the embedding training module 230 bases the jointly trained embedding 415 for that user on co-occurrences of events in Event 1 Data Set 405 and co-occurrences of events in Event 2 Data Set 410. A single embedding may be determined for users or content items in common between the data sets, and such users or content items may provide a means to link the learned embeddings in one data set with the other data set. Similarly, some content may appear in both the Event 1 Data Set 405 and the Event 2 Data Set 410. The embedding training module 230 bases the jointly trained embeddings 415 for content that has user-content pairings in both Event 1 Data Set 405 and Event 2 Data Set 410 on co-occurrences of events in the Event 1 Data Set 405 and co-occurrences of events in Event 2 Data Set 410.

To determine jointly trained embeddings 415 for users (or content items) that appear in both data sets, the embedding training module 230 may match users (or content items) that appear in both the Event 1 Data Set 405 and the Event 2 Data Set 410. For example, in some configurations users or content items may not be linked to a universal identifier or otherwise easily identified between the data sets. To perform this matching, the embedding training module 230 may first retrieve data characterizing a user in the Event 1 Data Set 405, and then retrieve other data characterizing a user in the Event 2 Data Set 410. The embedding training module 230 may then compare the retrieved data to determine whether the users match. The embedding training module 230 may perform these steps for each user in the Event 1 Data Set 405 and the Event 2 Data Set 410.

Some other users or content may only appear in one of the data sets 405 or 410. For example, if a user has viewed organically-presented videos, but has not viewed any advertising videos, this user may only have user-content pairs in Event 2 Data Set 410, but not Event 1 Data Set 405. The embedding training module 230 may train the jointly trained embeddings 415 that correspond to users or content that have user-content pairings in the Event 2 Data Set, but not the Event 1 Data Set, based on co-occurrences of events in the Event 2 Data Set. Similarly, the embedding training module 230 may train the jointly trained embeddings 415 that correspond to users or content that have user-content pairings in the Event 1 Data Set, but not the Event 2 Data Set, based on co-occurrences of events in the Event 1 Data Set.

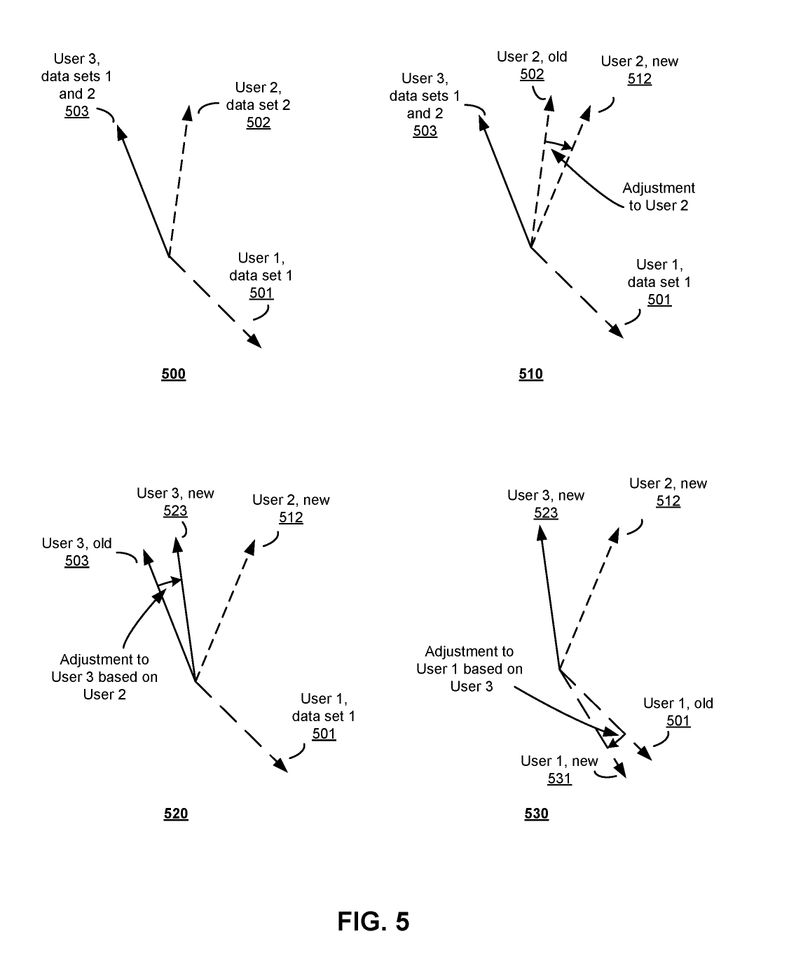

The jointly trained embeddings 415 for users or content that only appear in one data set 405 and 410 may still be affected by other users or content that appear in both data sets 405 and 410. In particular, the embedding training module 230 may further train the embeddings that correspond to users or content in one data set 405 or 410 based on embeddings that correspond to the users and content that appear in both data sets 405 and 410. In addition, the embedding training module 230 may indirectly train embeddings that correspond to users or content that are in one data set 405 or 410 by data in the other data set 410 or 405 by way of the embeddings that correspond to the set of users in common. For example, if an event logged in the Event 2 Data Set 410 impacts an embedding for a user with data in both the Event 1 Data Set 405 and the Event 1 Data Set 410, this may in turn impact an embedding for a user with data in only the Event 1 Data Set 405. This dynamic is further described with respect to FIG. 5.

After the embedding training module 230 generates the jointly trained embeddings 415, the jointly trained embeddings 415 and event 1 occurrence data 420 from the Event 1 Data Set 405 are used to train an Event 1 Prediction Model 425. The Event 1 Prediction Model 425 predicts the likelihood of occurrence of a future event of Event Type 1 based on a user and a content item. For example, the recommendation module 240 may train a computer model that can predict the likelihood of a Type 1 Event (e.g., a user viewing an advertising video) based on the Event 1 Occurrence Data and user and content embeddings from the jointly trained embeddings 415. The recommendation module 240 may then use the Event 1 Prediction Model 425 to generate an Event 1 Prediction based on Joint Embeddings 430. The Event 1 Prediction 430 may indicate, for example, the likelihood of a given user to view a given sponsored content item according to the jointly trained embeddings 415 of the user and the sponsored content item.

In some embodiments, the Event 1 Data Set 405 and the Event 2 Data Set 410 may be sampled or weighted in the jointly trained embeddings 415 based on, e.g., the relative sizes of the data sets or the relative importance of the data sets in making the prediction. For example, the embedding training module 230 may determine a sample size for one of the data sets 405 or 410 based on ratio of the sizes of the data sets. For example, a data set describing advertising video views may be much smaller than a data set describing organic video views. Accordingly, the sample size for the organic data may be determined based on the ratio of the data set sizes. The embedding module 230 may select a sample of the one of the data sets 405 or 410 based on the sample size. In other embodiments, the embedding module 230 uses all of the data in the Event 1 Data Set 405 and the Event 2 Data Set 410, but weighs some of the data, e.g., the Event 1 Data Set 405.

In some embodiments, the recommendation module 240 also trains an Event 2 Prediction Module based on the jointly trained embeddings 415. Alternatively, if the Event 2 Data Set 410 has enough data, the Event 2 Data Set 410 may be used to create Event 2-specific embeddings which are used by the recommendation module 240 to train the Event 2 Prediction Module. In some embodiments, the recommendation module 240 may rely on a joint embedding for a particular event type, or particular content, until enough data describing that event type or relating to that content has been obtained, and a more robust computer model can be generated based only on data relating to the event type.

FIG. 5 is an illustration of an interaction between joint embeddings, in accordance with an embodiment. In FIG. 5, embeddings are represented as two-dimensional vectors in a latent space. In general, the latent space is a vector space where each dimension or axis of the vector space is a latent or inferred characteristic of the objects in the space. However, as a simplified illustration, the latent space is shown in only two dimensions.

Diagram 500 includes three joint embeddings: embedding 501 for User 1, embedding 502 for User 2, and embedding 503 for User 3. The embedding 501 for User 1 was generated based on data in a first data set (data set 1), the embedding 502 for User 2 was generated based on data in a second data set (data set 2), and the embedding 503 for User 3 was generated based on data in both data set 1 and data set 2. The embedding 502 for User 2 is fairly close to the embedding 503 for User 3, and the embedding 501 for User 1 is far away from the embedding 503 for User 3. In the video watching example, this may indicate that Users 2 and 3 tend to watch similar videos, or have watched some of the same videos, whereas Users 1 and 3 watch very different videos, or have watched few or none of the same videos.

Diagram 510 shows an adjustment to User 2's embedding 502. For example, if User 2 performs an action logged in data set 2, this new data may adjust the embedding 502 for User 2, so that User 2 now has embedding 512. Embedding 512 has moved slightly clockwise relative to User 2's prior embedding 502.

Diagram 520 shows an adjustment to User 3's embedding based on the additional data on User 2. The embedding for User 3 has moved from the embedding 503 to a new embedding 523, which has also moved slightly clockwise relative to User 3's prior embedding 503. Because User 3's embedding is based off of data in both data sets, the additional data in data set 2 that moved User 2's embedding 512 may have also adjusted User 3's embedding 523. Alternatively, because User 3's initial embedding 503 was similar to User 2's embedding 502, the alteration to User 2's embedding, resulting in embedding 512, may in turn adjust User 3's embedding, resulting in new embedding 523, so that User 2 and User 3 retain similar embeddings 512 and 523 representing their similarity.

Diagram 530 shows an adjustment to User 1's embedding from the embedding 501 to a new embedding 531 based on the change to User 3's embedding 523. User 1's embedding 501 was determined mainly by data in data set 1, because User 1 does not have any data in data set 2. However, a change in data set 2 indirectly affects User 1's embedding 501 via the joint embeddings. For example, because User 3's embedding 523 is altered by the addition of data in data set 2, this impacts embeddings related to User 3, even if the related embeddings are based off of data in data set 1. Thus, to maintain the previous difference between User 3's embedding 503 and User 1's embedding 501, User 1's embedding 501 moves slightly clockwise to embedding 531, thus maintaining a similar relationship between User 1's and User 3's embeddings 531 and 523 as their prior relationship between embeddings 501 and 503 shown in diagram 500. Stated another way, by incorporating the additional data set, training the embeddings on the co-occurrence of events between users involves optimizing for the co-occurrence of additional types of events between the users.

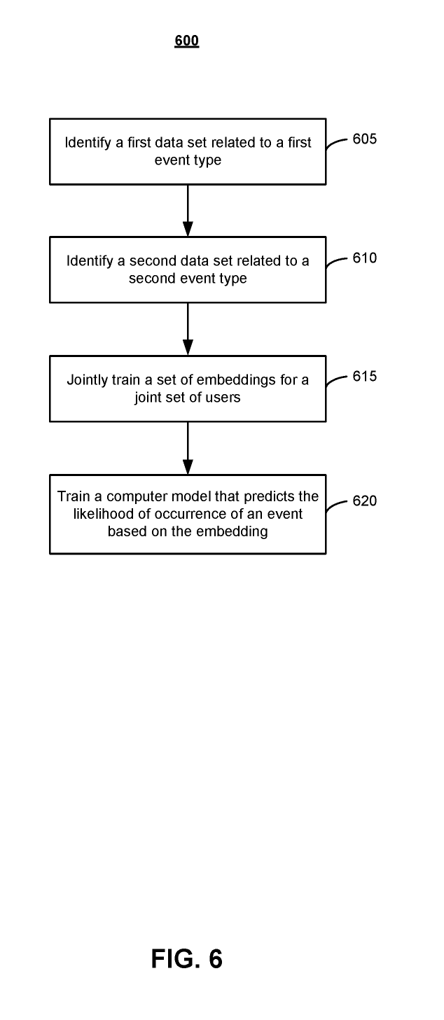

FIG. 6 is a flow diagram of a method for training a computer model that uses joint embeddings, in accordance with an embodiment.

At 605, the embedding training module 230 identifies at first data set related to a first event type. At 610, the embedding training module 230 identifies a second data set related to a second event types. The first data set and the second data set may be similar to the data sets 300 and 350 described with respect to FIG. 3, or Event 1 Data Set 405 and Event 2 Data Set 410 described with respect to FIG. 4. The first and second data sets may be logged in the action log 220.

At 615, the embedding training module 230 jointly trains a set of joint embeddings 235 for a joint set of users. For example, the joint embeddings that correspond to users that are described by data in both the first data set and the second data set are trained based on co-occurrences of events of the first event type in the first data set and co-occurrences of events of the second event type in the second data set. The joint training is described in further detail with respect to FIG. 4.

At 620, the recommendations module 240 trains a computer model that predicts the likelihood of occurrence of an event based on the joint embedding. For example, the computer model may predict the likelihood of an event of the first type based on occurrence data of the first event type and joint embeddings. The computer module is described above with respect to FIGS. 2 and 4.

It should be understood that the embedding training module can combine any number of data sets to create the joint embedding. For example, the embedding training module can combine two data sets, as described in detail herein, or can combine any number of additional data sets in a similar manner. The further data sets may all be combined in a single process, or the embedding training module may add additional data sets may be added to an existing joint embedding to further train the joint embedding. The embedding training module can combine any types of data sets describing different types of events, content, and users. For example, different data sets may include different events for the same type of content, or a single data set may include multiple related event types. Users may include individual users and entities (e.g., businesses or organizations). Content may include any type of content described above with respect to FIG. 2. The data set may pair any type (or multiple types) of user with any type of content (or multiple types of content), and log any type of action the user can take with respect to the content.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
identifying a first data set describing occurrences of a first event type, the first data set comprising a first plurality of user-content pairs relating a first set of users with content for which the first event type was observed;
identifying a second data set describing occurrences of a second event type, the second data set comprising a second plurality of user-content pairs relating a second set of users with content for which the second event type was observed, the second set of users and the first set of users having a set of users in common;
jointly training a set of embeddings for a joint set of users comprising the users in the first set of users and the users in the second set of users, wherein embeddings that correspond to the set of users in common are trained based on co-occurrences of events of the first event type in the first plurality of user-content pairs and co-occurrences of events of the second event type in the second plurality of user content pairs; and
training a computer model that predicts the likelihood of occurrence of a future event of the first event type for a user with respect to a content item based on the embedding for the user in the jointly trained set of embeddings.

2. The method of claim 1, further comprising:
training embeddings that correspond to users that are in the first set of users, but not the set of users in common, based on co-occurrences of events of the first event type in the first plurality of user-content pairs; and
training embeddings that correspond to users that are in the second set of users, but not the set of users in common, are trained based on co-occurrences of events of the second event type in the second plurality of user-content pairs.

3. The method of claim 2, further comprising:
further training the embeddings that correspond to the users that are in the first set of users, but not the set of users in common, based on the embeddings that correspond to the set of users in common; and
further training the embeddings that correspond to the users that are in the second set of users, but not the set of users in common, based on the embeddings that correspond to the set of users in common.

4. The method of claim 3, wherein the embeddings that correspond to users that are in the first set of users, but not the set of users in common, are indirectly trained by the second plurality of user-content pairs by way of the embeddings that correspond to the set of users in common.

5. The method of claim 1, wherein the first plurality of user-content pairs further relates a first set of content to users for which the first event type was observed, and the second plurality of user-content pairs further relates a second set of content to users for which the first event type was observed, the method further comprising:
jointly training a set of embeddings for a joint set of content comprising the content in the first set of content and the content in the second set of content.

6. The method of claim 5, further comprising:
identifying a set of content in common by matching content of the first set of content in the first data set to content of the second set of content in the second data set;
wherein embeddings that correspond to the set of content in common are trained based on co-occurrences of events of the first event type in the first plurality of user-content pairs and co-occurrences of events of the second event type in the second plurality of user content pairs, wherein the embeddings that correspond to content that is in the first set of content, but not the set of content in common, are trained based on co-occurrences of events of the first event type in the first plurality of user-content pairs, and the embeddings that correspond to content that is in the second set of content, but not the set of content in common, are trained based on co-occurrences of events of the second event type in the second plurality of user-content pairs.

7. The method of claim 1, further comprising:
determining a sample size for the second plurality of user-content pairs based on ratio of a size of the first data set and a size of the second data set; and
selecting a sample of the second plurality of user-content pairs based on the sample size;
wherein the set of embeddings for the joint set of users are jointly trained based on the first plurality of user-content pairs and sample of the second plurality of the user-content pairs.

8. The method of claim 1, wherein:
the first data set describes interactions between the first set of users and one or more advertisements, and the first event type is a conversion event; and
the second data set describes interactions between the second set of users and one or more content items in a non-promotional content channel.

9. The method of claim 8, wherein a content item described in the second data set matches an advertisement described in the first data set.

10. The method of claim 1, wherein:
the first data set describes interactions between the first set of users and one or more advertisements, and the first event type describes a first type of conversion event; and
the second data set describes interactions between the second set of users and one or more advertisements, and the second event type describes a second type of conversion event different from the first type of conversion event.

11. The method of claim 1, further comprising identifying the set of users in common by matching users of the first set of users to users of the second set of users; the matching comprising:
retrieving first data characterizing a first user of the first set of users;
retrieving second data characterizing a second user of the second set of users; and
comparing the first data and the second data to determine whether the first user matches the second user.

12. A computer-readable medium containing computer program code executable on a processor for:
identifying a first data set describing occurrences of a first event type, the first data set comprising a first plurality of user-content pairs relating a first set of users with content for which the first event type was observed;
identifying a second data set describing occurrences of a second event type, the second data set comprising a second plurality of user-content pairs relating a second set of users with content for which the second event type was observed, the second set of users and the first set of users having a set of users in common;
jointly training a set of embeddings for a joint set of users comprising the users in the first set of users and the users in the second set of users, wherein embeddings that correspond to the set of users in common are trained based on co-occurrences of events of the first event type in the first plurality of user-content pairs and co-occurrences of events of the second event type in the second plurality of user content pairs; and
training a computer model that predicts the likelihood of occurrence of a future event of the first event type for a user with respect to a content item based on the embedding for the user in the jointly trained set of embeddings.

13. The computer-readable medium of claim 12, further containing computer program code executable on a processor for:
training embeddings that correspond to users that are in the first set of users, but not the set of users in common, based on co-occurrences of events of the first event type in the first plurality of user-content pairs; and
training embeddings that correspond to users that are in the second set of users, but not the set of users in common, are trained based on co-occurrences of events of the second event type in the second plurality of user-content pairs.

14. The computer-readable medium of claim 13, further containing computer program code executable on a processor for:
further training the embeddings that correspond to the users that are in the first set of users, but not the set of users in common, based on the embeddings that correspond to the set of users in common; and
further training the embeddings that correspond to the users that are in the second set of users, but not the set of users in common, based on the embeddings that correspond to the set of users in common.

15. The computer-readable medium of claim 14, wherein the embeddings that correspond to users that are in the first set of users, but not the set of users in common, are indirectly trained by the second plurality of user-content pairs by way of the embeddings that correspond to the set of users in common.

16. The computer-readable medium of claim 12, wherein the first plurality of user-content pairs further relates a first set of content to users for which the first event type was observed, and the second plurality of user-content pairs further relates a second set of content to users for which the first event type was observed, the computer-readable medium further containing computer program code executable on a processor for:
jointly training a set of embeddings for a joint set of content comprising the content in the first set of content and the content in the second set of content.

17. The computer-readable medium of claim 16, further containing computer program code executable on a processor for:
identifying a set of content in common by matching content of the first set of content in the first data set to content of the second set of content in the second data set;
wherein embeddings that correspond to the set of content in common are trained based on co-occurrences of events of the first event type in the first plurality of user-content pairs and co-occurrences of events of the second event type in the second plurality of user content pairs, wherein the embeddings that correspond to content that is in the first set of content, but not the set of content in common, are trained based on co-occurrences of events of the first event type in the first plurality of user-content pairs, and the embeddings that correspond to content that is in the second set of content, but not the set of content in common, are trained based on co-occurrences of events of the second event type in the second plurality of user-content pairs.

18. The computer-readable medium of claim 12, further containing computer program code executable on a processor for:
determining a sample size for the second plurality of user-content pairs based on ratio of a size of the first data set and a size of the second data set; and
selecting a sample of the second plurality of user-content pairs based on the sample size;
wherein the set of embeddings for the joint set of users are jointly trained based on the first plurality of user-content pairs and sample of the second plurality of the user-content pairs.

19. The computer-readable medium of claim 12, further containing computer program code executable on a processor for identifying the set of users in common by matching users of the first set of users to users of the second set of users; the matching comprising:
retrieving first data characterizing a first user of the first set of users;
retrieving second data characterizing a second user of the second set of users; and
comparing the first data and the second data to determine whether the first user matches the second user.
